(19) United States
(12) Patent Application Publication
(10) Pub. No.: US 2010/0008735 A1
(43) Pub. Date: Jan. 14, 2010

(54) MILLING CUTTER WITH CAM PIN AND CUTTING INSERT THEREFOR

(76) Inventors: Ronald L. Dudzinsky, Derry, PA (US); Thomas J. Long, II, Greensburg, PA (US); Shawn E. Frye, Latrobe, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/169,051

(22) Filed: Jul. 8, 2008

(51) Int. Cl. B26D 1/12; B26D 3/00

(52) U.S. Cl. 407/48; 407/114

(57) ABSTRACT

A milling cutter includes a shank having an insert pocket and a cam pin hole. The insert pocket includes a bottom surface, a radial seating surface and an axial seating surface. A cutting insert is mounted in the insert pocket. The cutting insert includes a blind hole extending from a bottom surface. A cam pin is rotatably mounted in the cam pin hole. One end of the cam pin includes a raised boss received in the blind hole of the cutting insert. A center axis of the raised boss is offset from a center axis of the cam pin such that rotation of the cam pin causes the raised boss to exert pressure against the blind hole of the cutting insert, thereby causing one of the side walls of the cutting insert to be forced against the radial seating surface of the insert pocket.

### BACKGROUND OF THE INVENTION

The invention relates to a cutting insert for a high-speed cutting operation, and more particularly, to an indexable cutting insert for a high-speed milling cutter that includes a cam pin that forces the cutting insert against the radial seating wall of the insert pocket to minimize or eliminate movement of the cutting insert and the resulting bending moment on the insert mounting screw.

Milling cutters for performing machining operations on metallic work pieces are well known in the prior art. Such cutters typically comprise a cylindrical or disc-shaped body which is detachably connectable to a rotating drive shaft. Cutting inserts are mounted around the outer periphery of the cutter body for producing a series of metal-shaving cuts on a work piece. In operation, such milling cutters are typically rotated at speeds of several thousand rpm while a work piece is engaged with the inserts mounted on the cutter body.

Recently, there has been an increased demand for milling cutters capable of operating at rotational speeds far in excess of several thousand rpm. The advantages associated with such high-speed milling include a faster cutting action which results in a higher metal removal rate on the work piece, a reduction in the cutting forces applied to the cutting inserts by the work piece, and a smoother final cut. Such reduced cutting forces protract the operating life of the inserts, not only reducing the costs associated with insert replacement, but also the amount of downtime necessary to reorient the cutting edges of indexable inserts. The cost and time of fixturing is also reduced because higher cutting forces require more elaborate and more rigid fixturing to achieve desired accuracy.

As a result of these advantages, a high-speed milling cutter not only lowers machining costs while increasing productivity, but also enhances the quality of the final machined work piece since the cutting action is smoother, and leaves a better finish. It will be appreciated that the substantial increase in rotational speed necessary to obtain all the aforementioned advantages also results in a substantial increase in the centrifugal forces generated in the body of the cutter. Generally speaking, the centrifugal force F_{c} is dependent upon the mass (m) of the cutter body supporting the cutting insert, the length of the radius (r) of the cutter body, and the square of the angular velocity (Ω) of the body. The relationship between these parameters may be expressed in the equation F_{c}=(mΩ²) (r). The fact that the centrifugal force (and hence tensile stress) on the cutter body increases with the square of the angular velocity has, up to now, posed a substantial obstacle in the development of a milling cutter capable of operating at speeds higher than several thousand rpm. A milling cutter rotating at 10,000 rpm would have 25 times more centrifugally induced tensile stress along its periphery than when it was operated at 2,000 rpm. If the same cutter is spun at 20,000 rpm, it would have over 100 times more centrifugally induced tensile stress.

In addition, the substantial increase in rotational speed necessary to obtain all the aforementioned advantages also results in a substantial increase in the centrifugal forces generated on the inserts of the cutter. Specifically, the centrifugal forces tend to cause the inserts to become unseated from the insert pocket during high-speed milling operations. Thus, there is a need for a high-speed milling cutter capable of operating at high speeds, for example, about 20,000 rpm that securely and positively retains the cutting inserts within the insert pockets of the cutter body. Ideally, such a high-speed milling cutter and cutting inserts should be relatively inexpensive to manufacture, and should utilize inexpensive, readily replaceable cutting inserts so as to minimize both the cost of fabrication and operation of the device.

### BRIEF SUMMARY OF THE INVENTION

Briefly, according to this invention, there is provided a milling cutter comprising a shank having an insert pocket and a cam pin hole. The insert pocket includes a bottom surface, a radial seating surface and an axial seating surface. A cutting insert is mounted in the insert pocket. The cutting insert has a top surface, a bottom surface, and a plurality of side surfaces extending from the bottom surface to the top surface. The cutting insert further includes a blind hole extending from the bottom surface. A cam pin has one end rotatably mounted in the cam pin hole, and the other end of the cam pin includes a raised boss received in the blind hole of the cutting insert when the cutting insert is mounted in the insert pocket. A center axis of the raised boss is offset from a center axis of the cam pin such that rotation of the cam pin causes the raised boss to exert pressure against the blind hole of the cutting insert, thereby causing one of the side walls of the cutting insert to be forced against the radial seating wall of the insert pocket.

In another embodiment, a cutting insert capable of being mounted in an insert pocket of a milling cutter comprises a top surface; a bottom surface; a plurality of side surfaces extending from the bottom surface to the top surface; and a blind hole extending from the bottom surface, the blind hole capable of receiving a cam pin that exerts pressure against the blind hole, thereby causing one of the side walls of the cutting insert to be forced against a radial seating wall of the insert pocket.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an exploded perspective view of a milling cutter with cam pin and an indexable cutting insert according to an embodiment of the invention;

FIG. 2 is another exploded perspective view of the milling cutter with cam pin and the indexable cutting insert of FIG. 1;

FIG. 3 is a perspective view of the milling cutter with the cutting insert mounted thereto;

FIG. 4 is an enlarged front perspective view of the insert pocket of the milling cutter with the cutting insert mounted thereto;

FIG. 5 is a cross-sectional view taken along line 5-5 of FIG. 4 of the cam pin at its maximum travel forcing the cutting insert securely against the radial seating wall of the insert pocket; and

FIG. 6 is a cross-sectional view taken along line 6-6 of FIG. 4 that illustrates the cam pin at its maximum travel forcing the cutting insert securely against the radial seating wall of the insert pocket and a set screw that prevents movement of the cam pin.

### DETAILED DESCRIPTION OF THE INVENTION

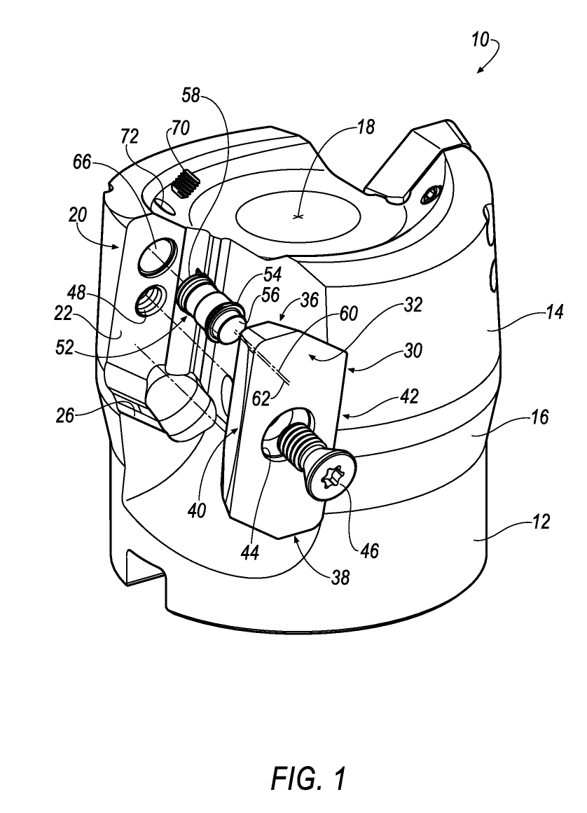

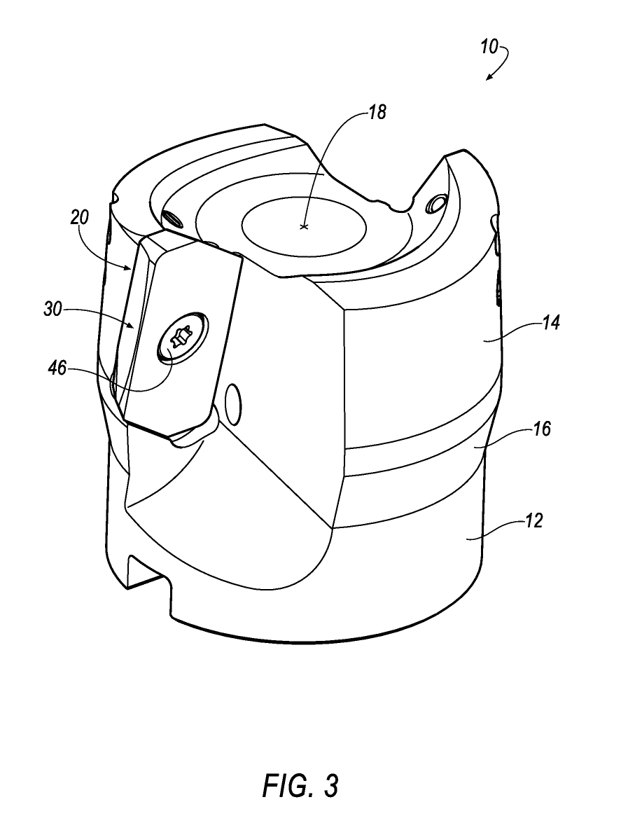

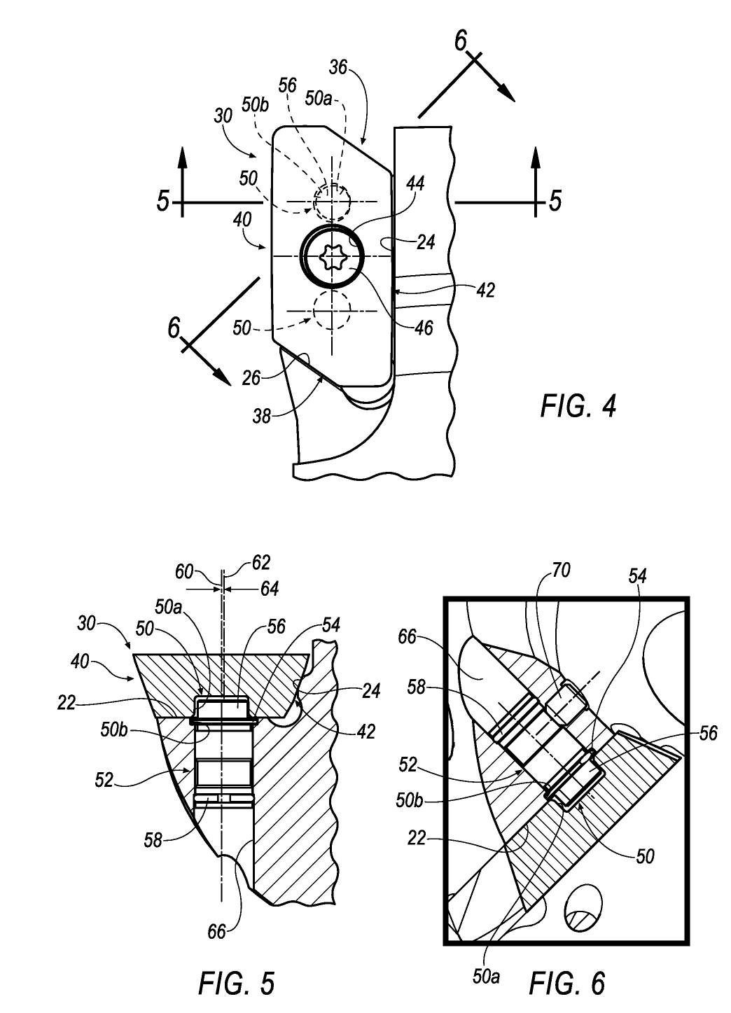

With reference now to the drawings, wherein like numerals designate like components throughout all of the several figures, FIGS. 1-6 illustrate a milling cutter, shown generally at 10, according to an embodiment of the invention. In general, the milling cutter 10 includes a shank 12, an upper portion 14 and a transition surface 16 between the shank 12 and the upper portion 14. The cutter 10 is preferably made from heat-treated steel, such as H13 tool steel, or other materials known to those skilled in the art. The specific material used will vary as a consequence of desired design characteristics of the cutter 10. The cutter 10 is rotated about an axis 18. The cutter 10 also includes an insert pocket, shown generally at 20, formed at the leading end of the upper portion 14 of the cutter 10. As shown in FIG. 1, the insert pocket 20 includes a bottom surface 22, a radial seating surface 24 and an axial seating surface 26.

In the illustrated embodiment, the milling cutter 10 is capable of mounting two cutting inserts 30 oriented about 180° with respect to each other within a respective insert pocket 10. However, it will be appreciated that the milling cutter of the invention is not limited by the number of indexable cutting inserts 30 that can be mounted in the insert pockets 20, and that the invention can be practiced with any desired number of cutting inserts limited by only the physical limitations of the material properties of the milling cutter.

In general, the indexable cutting insert 30 includes generally, a top surface 32, a bottom surface 34 and side surfaces 36, 38, 40, 42. In one embodiment, the topography of the surfaces of the cutting insert 30 is similar to the topography described in commonly-assigned U.S. Pat. No. 7,070,363, the entire contents of which are herein incorporated by reference. The cutting insert 30 includes a countersunk bore 44 that extends from the top surface 32 to the bottom surface 34. The countersunk bore 44 may a marginally larger diameter at the top surface 32 than its diameter at the bottom surface 34. The countersunk bore 44 is capable of receiving a threaded fastener 46, such as an insert mounting screw, that is threadingly received in a threaded bore 48 in the bottom surface 22 of the insert pocket 20. Ideally, the countersunk bore 44 is centrally located in the cutting insert 30 and is substantially aligned with the threaded bore 48 of the insert pocket 20 when the cutting insert 30 is properly mounted in the insert pocket 20.

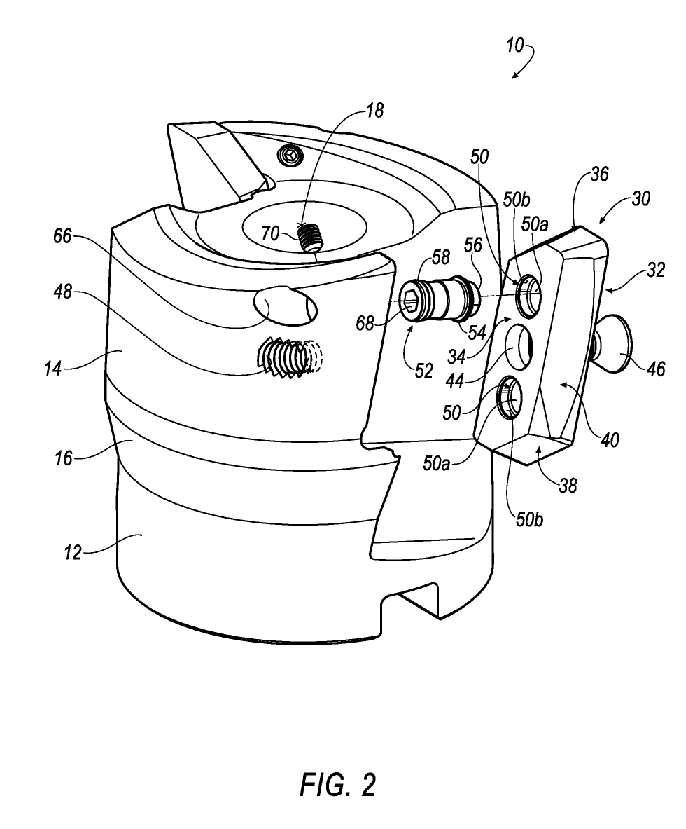

One aspect of the invention is that the cutting insert 30 includes one or more blind holes 50 that extend from the bottom surface 34, but does not extend to the top surface 32, as shown in FIGS. 1 and 2. In the illustrated embodiment, the cutting insert 30 includes two blind holes 50 that are equidistant from the countersunk bore 44 to allow the cutting insert 30 to be indexed 180 degrees for using two cutting edges. In the illustrated embodiment, the blind hole 50 includes a relatively smaller diameter upper portion 50a and a relatively larger diameter lower portion 50b. In an alternate embodiment, the blind hole 50 may have a substantially uniform diameter that does not include the upper and lower portions 50a, 50b. It will be appreciated that the invention can be practiced with any desirable number of blind holes, depending on whether the cutting insert is indexable or not. If the cutting insert is indexable, then the number of blind holes should be equal to the number of indexable cutting edges of the insert. For example, if the cutting insert has four cutting edges, then the cutting insert should have four blind holes; one for each cutting edge.

Another aspect of the invention is that the milling cutter 10 includes a cam pin, shown generally at 52 in FIGS. 1 and 2. The cam pin 52 is generally cylindrical in shape and includes a flange 54, a raised boss 56 and a split ring 58. As shown in FIGS. 1 and 5, the flange 54 and the split ring 58 are located about a center axis 60 of the cam pin 52, whereas, the raised boss 56 is located about a center axis 62 that is offset by a distance 64 with respect to the center axis 60. In one embodiment, the distance 64 is about 0.22 mm (about 0.0087 inches). In this manner, the raised boss 56 acts as a cam as the cam pin 52 rotates about its center axis 60.

As shown in FIGS. 5 and 6, the raised boss 56 is capable of being received within the upper portion 50a of the blind hole 50 of the cutting insert 30, and the flange 54 is capable of being received within the lower portion 50b of the blind hole 50 of the cutting insert 30. In the embodiment in which the blind hole 50 does not include the upper and lower portions 50a, 50b, the flange 54 is capable of being received in a counter bore in the bottom surface 22 of the insert pocket 20. The split ring 58 located at the other end of the cam pin 52 is capable of being received within a cam pin hole 66 located in the bottom surface 22 of the insert pocket 20. The split ring 58 provides a snap fit arrangement that enables the cam pin 52 to be rotatably mounted within the cam pin hole 66 in a relatively fixed radial position. In other words, the cam pin 52 is capable of being rotated while being held in a relatively fixed position within the cam pin hole 66. The cam pin hole 66 extends through the upper portion 14 of the milling cutter 10 to allow a tool (not shown), such as a hexagonal wrench, to be inserted into a tool access 68 of the cam pin 52 and rotate the cam pin 62.

The milling cutter 10 also includes a means for limiting movement of the cam pin 52 during machining operations. In the illustrated embodiment, the limiting means comprises a set screw 70 is provided to engage the cam pin 52 to limit movement of the cam pin 52 during machining operations, as shown in FIGS. 1, 2 and 6. The set screw 70 is threadingly received in a threaded set screw hole 72, as shown in FIG. 1. Ideally, the set screw hole 72 is substantially perpendicular to the cam pin hole 66 to firmly hold the cam pin 52 in place. In the illustrated embodiment, the set screw 70 engages the cam pin 52 between the flange 54 and the split ring 58, as shown in FIG. 6. It will be appreciated that the invention is not limited by the use of the set screw to limit or prevent unwanted movement of the cam pin during machining operations, and that the invention can be practiced with other means known in the art for locking the cam pin in place.

In operation, a portion of the cam pin 52 is inserted into the cam pin hole 66. Then, the cutting insert 30 is mounted on the insert pocket 20 using the insert mounting screw 46. Then, a tool (not shown) is inserted into the tool access 68 and the cam pin 52 is rotated about the central axis 60 such that the raised boss 56 of the cam pin 52 engages and exerts a radial force against the upper portion 50a of the blind hole 50 of the cutting insert 30, thereby forcing the cutting insert 30 in a radial direction against the radial seating surface 24 of the insert pocket 20. The cam pin 52 can be rotated such that the cam pin 52 exerts a maximum amount of force in the radial direction against the cutting insert 30. Then, the set screw 70 is rotated until the set screw 70 firmly engages the cam pin 52 to prevent unwanted movement of the cam pin 52 during machining operations. Because the cutting insert 30 is held firmly against the radial seating surface 24 of the insert pocket 20, the insert mounting screw 46 experiences less bending moments during high-speed milling operations as compared to conventional milling cutters.

It will be appreciated that the principles of the invention can be applied to other types of cutters, such as turning, lathe, and the like.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

What is claimed is:

1. A milling cutter, comprising:
a shank;
an upper portion having an insert pocket and a cam pin hole, the insert pocket including a bottom surface, a radial seating surface and an axial seating surface;
a cutting insert mounted in the insert pocket, the cutting insert having a top surface, a bottom surface, and a plurality of side surfaces extending from the bottom surface to the top surface, the cutting insert further including a blind hole extending from the bottom surface; and
a cam pin having one end rotatably mounted in the cam pin hole, the other end of the cam pin including a raised boss received in the blind hole of the cutting insert when the cutting insert is mounted in the insert pocket, a center axis of the raised boss being offset from a center axis of the cam pin,
wherein rotation of the cam pin causes the raised boss to exert pressure against the blind hole of the cutting insert, thereby causing one of the side walls of the cutting insert to be forced against the radial seating surface of the insert pocket.

2. The milling cutter of claim 1, wherein the shank includes a threaded bore, and wherein the cutting insert includes a countersunk bore capable of receiving a threaded fastener, and wherein the cutting insert is mounted to the insert pocket by inserting the threaded fastener through the countersunk bore and threading the threaded fastener into the threaded bore.

3. The milling cutter of claim 1, wherein the blind hole further comprises an upper portion and a lower portion.

4. The milling cutter of claim 3, wherein the raised boss is received in the upper portion of the blind hole, and wherein the cam pin further includes a flange received in the lower portion of the blind hole when the cutting insert is mounted in the insert pocket.

5. The milling cutter of claim 1, wherein the cam pin is rotatably mounted in the cam pin hole using a split ring that is snapped into the cam pin hole.

6. The milling cutter of claim 1, further comprising limiting means for limiting movement of the cam pin during machining operations.

7. The milling cutting of claim 6, wherein the limiting means comprises a set screw that engages the cam pin.

8. The milling cutter of claim 1, further comprising a transition surface between the upper portion and the shank.

9. The milling cutter of claim 1, wherein the cutting insert is indexable.

10. A cutting insert capable of being mounted in an insert pocket of a milling cutter, comprising:
a top surface;
a bottom surface;
a plurality of side surfaces extending from the bottom surface to the top surface; and
a blind hole extending from the bottom surface, the blind hole capable of receiving a cam pin that exerts pressure against the blind hole, thereby causing one of the side walls of the cutting insert to be forced against a radial seating surface of the insert pocket.
